(19) United States
(12) Patent Application Publication
(10) Pub. No.: US 2025/0128442 A1
(43) Pub. Date: Apr. 24, 2025

(54) RAZOR CARTRIDGE AND RAZOR ASSEMBLY INCLUDING THE SAME

(71) Applicant: DORCO CO., LTD., Seoul (KR)

(72) Inventor: Da Woon HAN, Seoul (KR)

(21) Appl. No.: 18/917,871

(22) Filed: Oct. 16, 2024

(30) Foreign Application Priority Data
Oct. 18, 2023 (KR) 10-2023-0139771

(51) Int. Cl. B26B 21/52; B26B 21/22; B26B 21/40

(52) U.S. Cl. CPC B26B 21/521; B26B 21/225; B26B 21/4018

(57) ABSTRACT

A razor assembly is proposed. The razor assembly may include a razor handle, at least one razor blade having a cutting edge formed thereon. The razor assembly may also include a blade housing including a razor blade mounting portion in which the razor blade is accommodated in a longitudinal direction, an upper surface on which the razor blade is exposed, and a lower surface opposite to the upper surface. The razor assembly may further include a connector disposed adjacent to the lower surface and including a connecting groove into which the razor handle enters. An indicator providing mounting information of the razor handle may be provided within the connecting groove.

### CROSS REFERENCE TO RELATED APPLICATION

This application claims priority from Republic of Korea Patent Application No. 10-2023-0139771, filed on Oct. 18, 2023, which is hereby incorporated by reference in its entirety.

### BACKGROUND

### Technical Field

The present disclosure relates to a razor cartridge and a razor assembly including the same, and more specifically, to a razor cartridge accommodating at least one razor blade, and a razor assembly including the razor cartridge and a razor handle.

### Description of Related Technology

Generally, a razor is a product for cutting hair such as facial hair or beard, and includes a razor handle for gripping and a razor cartridge having a razor blade that comes into contact with a skin to perform shaving.

### SUMMARY

One aspect is a razor cartridge in which information related to the mounting of the razor handle is easily visually recognized.

The aspects of the present disclosure are not limited to the aspects described above, and other aspects not mentioned can be clearly understood by those skilled in the art from the description below.

Another aspect is a razor assembly including: a razor handle; at least one razor blade having a cutting edge formed thereon; a blade housing including a razor blade mounting portion in which the razor blade is accommodated in a longitudinal direction, an upper surface on which the razor blade is exposed, and a lower surface opposite to the upper surface; and a connector formed adjacent to the lower surface and including a connecting groove into which the razor handle enters, in which an indicator providing mounting information of the razor handle is provided within the connecting groove.

Another aspect is a razor cartridge including: at least one razor blade having a cutting edge formed thereon; and a blade housing having a razor blade mounting portion formed at an upper surface in which the razor blade is accommodated in a longitudinal direction, and a connector provided at a lower surface to which a razor handle is coupled, in which the connector includes a pair of connecting posts formed at both sides of a space into which the razor handle enters, and an indicator indicating an entry position of the razor handle is displayed between the pair of connecting posts.

Other specific details of the present disclosure are included in the detailed description and drawings.

According to embodiments of the present invention, at least the following effects are provided.

A razor cartridge according to an embodiment of the present invention includes an indicator that allows information related to the mounting of a razor handle to be easily visually recognized in a space where the razor handle enters, thereby allowing a user to easily connect the razor handle and the razor cartridge.

Other specific details of the present disclosure are included in the detailed description and drawings.

### BRIEF DESCRIPTION OF THE DRAWINGS

FIG. 1 is a side view schematically illustrating a razor assembly according to one embodiment of the present disclosure.

FIG. 2 is a perspective view illustrating a razor cartridge according to one embodiment of the present disclosure.

FIG. 3 is a bottom view of the razor cartridge according to one embodiment of the present disclosure.

FIG. 4 is an exploded perspective view of the razor cartridge according to one embodiment of the present disclosure.

FIG. 5 is a perspective view of a lower surface of an elastic guard of the razor cartridge according to one embodiment of the present disclosure.

FIG. 6 is a perspective view illustrating a cross section of the razor cartridge according to one embodiment of the present disclosure.

FIG. 7 is a sectional view of the razor cartridge according to one embodiment of the present disclosure.

FIG. 8 is an exploded perspective view of a razor cartridge according to another embodiment of the present disclosure.

### DETAILED DESCRIPTION

In order for the razor cartridge to close to the skin according to the shape of the user's skin surface with various curves, the razor cartridge is rotatably connected to the razor handle.

In addition, in order to replace the razor cartridge, the razor cartridge and the razor handle have a structure that allows the razor cartridge to be detached from the razor handle.

However, the structure and method of connecting the razor cartridge and the razor handle are different depending on the manufacturer, and even among products of the same manufacturer, there are products that are not compatible.

Therefore, when using a new razor cartridge and/or a new razor handle, the razor user must check the method of connecting/detaching the razor cartridge and the razor handle.

When the razor cartridge and the razor handle are abnormally connected, such as by attaching the razor cartridge to the razor handle in the wrong direction or forcibly attaching the razor cartridge and the razor handle that are not compatible with each other, problems such as damage occurring during the separation process due to difficulty in normal separation of the razor cartridge and the razor handle, separation of the razor cartridge during shaving, or injury occurring during shaving due to the razor cartridge not pivoting normally may occur.

However, since the size of the razor cartridge is small and most of the razor cartridges on the market use dark-colored frames, it is sometimes difficult for the user to immediately identify the location and structure of the connector existing in the razor cartridge.

The advantages and features of the present disclosure, and the method for achieving them will be clarified by referring to the embodiments described in detail below with the attached drawings. However, the present disclosure is not limited to the embodiments disclosed below, but may be implemented in various different forms, and these embodiments are provided only to ensure that the disclosure of the present disclosure is complete and to fully inform a person having ordinary knowledge in the technical field to which the present disclosure belongs of the scope of the disclosure, and the present disclosure is defined only by the scope of the claims.

In addition, the embodiments described in the present specification will be described with reference to cross sectional views and/or schematic views, which are ideal examples of the present disclosure. Accordingly, the form of the examples may be modified due to manufacturing technology and/or tolerances. In addition, each component in each drawing illustrated in the present disclosure may be illustrated somewhat enlarged or reduced in consideration of the convenience of explanation. The same reference numerals refer to the same components throughout the specification.

In addition, when describing the components of the embodiments of the present disclosure, symbols such as first, second, i), ii), a), b) may be used. These symbols are only for distinguishing the components from other components, and the nature or order or sequence of the components is not limited by the symbols. When a part of the specification is said to “include” or “provide” a component, this does not mean that other components are excluded, but rather that other components may be further included, unless explicitly stated otherwise.

Hereinafter, the present disclosure will be described with reference to drawings for explaining a razor cartridge according to embodiments of the present disclosure and a razor assembly including the same.

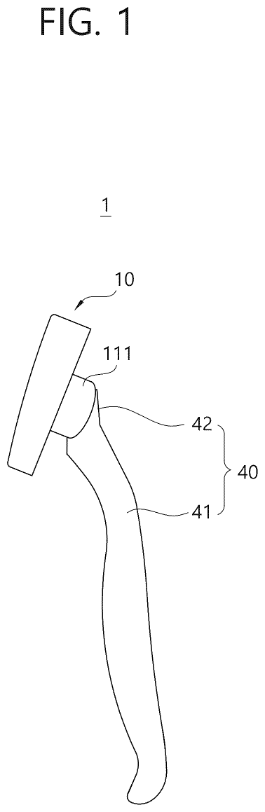

FIG. 1 is a side view schematically illustrating a razor assembly according to one embodiment of the present disclosure.

Referring to FIG. 1, a razor assembly 1 according to one embodiment of the present disclosure includes a razor cartridge 10 and a razor handle 40 to which the razor cartridge 10 is rotatably coupled.

The razor handle 40 includes a handle body 41 and a handle head 42.

The handle body 41 is a portion that is gripped by the user.

The handle head 42 is provided at one end of the handle body 41 and is detachably coupled to a connector 111 of the razor cartridge 10, and can rotatably support the coupled razor cartridge 10. Although not illustrated, a connecting member coupled to the connector 111 may be provided at the end portion of the handle head 42.

Below, razor cartridges according to embodiments of the present invention is described.

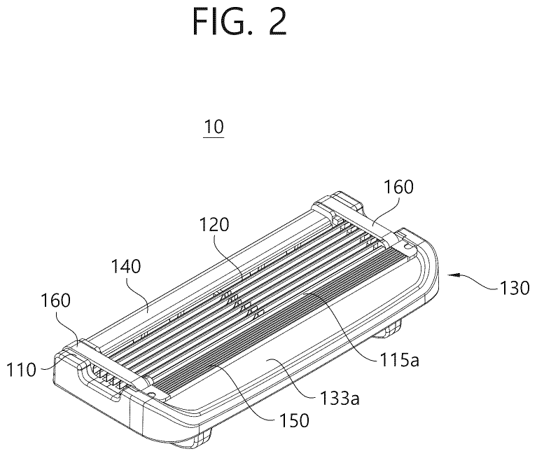

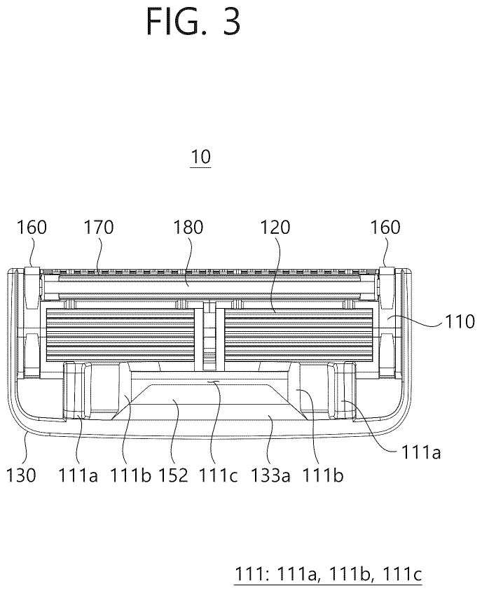

FIG. 2 is a perspective view illustrating a razor cartridge according to one embodiment of the present disclosure, and FIG. 3 is a bottom view of the razor cartridge according to one embodiment of the present disclosure.

Referring to FIGS. 2 and 3, the razor cartridge 10 according to the embodiment of the present disclosure includes a blade housing 110, a plurality of razor blades 120, and a housing cover 130.

The blade housing 110 accommodates each razor blade 120 in a longitudinal direction. Each razor blade 120 may be arranged in a transverse row. With reference to FIG. 3, the longitudinal direction means a horizontal direction, and the transverse direction means a vertical direction. Although FIGS. 2 and 3 illustrate an example in which six razor blades 120 are included in the razor cartridge 10, the number of razor blades 120 may vary depending on the embodiment.

An upper surface of the blade housing 110 described below is a surface that comes into contact with or faces a user's skin during a shaving process. A lower surface of the blade housing 110 is a surface located on a side opposite to the upper surface, and the lower surface of the blade housing 110 is illustrated in FIG. 3.

The front of the blade housing 110 may be the direction (shaving direction) in which the blade housing 110 moves relative to the user's skin during the shaving process. For example, the front of the blade housing 110 means downward with reference to FIG. 3.

The rear of the blade housing 110 means upward with reference to FIG. 3 in a direction opposite to the aforementioned front.

Referring to FIG. 3, the razor cartridge 10 may include the connector 111 provided to be adjacent to the lower surface of the blade housing 110.

The connector 111 is configured to be detachably coupled with the razor handle 40. The connector 111 may be coupled to the lower surface of the blade housing 110 or formed integrally with the blade housing 110. Alternatively, the connector 111 may be coupled to the lower surface of the housing cover 130 described below or may be formed integrally with the housing cover 130. Alternatively, a portion of the connector 111 may be provided in the blade housing 110 and the remaining portion thereof may be provided in the housing cover 130. For convenience of explanation, the following description will be based on an example in which the connector 111 is provided in the lower surface of the blade housing 110.

The connector 111 may include a pair of connecting posts 111a, a pair of guide surfaces 111b, and a connecting groove 111c.

The pair of connecting posts 111a may be formed to protrude from the blade housing 110 in a state of being longitudinally spaced apart from each other. A space between the pair of connecting posts 111a forms a space into which a connecting member of the razor handle 40, which will be described later, enters. The connecting member is a member that is detachably coupled with the connector 111.

The pair of guide surfaces 111b are provided between the connecting groove 111c and the pair of connecting posts 111a to guide the connecting member of the razor handle 40 to enter the connecting groove 111c. To this end, the pair of guide surfaces 111b may include a downwardly inclined surface from the pair of connecting posts 111a toward the connecting groove 111c.

The connecting groove 111c accommodates a connecting member of the razor handle 40 and is releasably coupled with the connecting member. For example, the connecting groove 111c may be configured to enable a releasable hook couple with the connecting member. Referring to FIG. 3, at least a portion of the connecting groove 111c may be opened toward a lower portion of the blade housing 110 so that the connecting member of the razor handle 40 may enter toward the connecting groove 111c from a lower portion of the razor cartridge 10. Referring to FIG. 2, the razor cartridge 10 may be configured so that the connecting groove 111c is not exposed to the upper surface. To this end, an upper portion of the connecting groove 111c may be configured to be blocked by at least one of the blade housing 110, the elastic guard 150, and the housing cover 130.

Referring to FIG. 3, the razor cartridge 10 according to one embodiment of the present disclosure may have an indicator 152 displayed between the pair of connecting posts 111a.

The pair of connecting posts 111a and the indicator 152 may be arranged on the same line in the longitudinal direction, and the indicator 152 may be displayed in the connecting groove 111c.

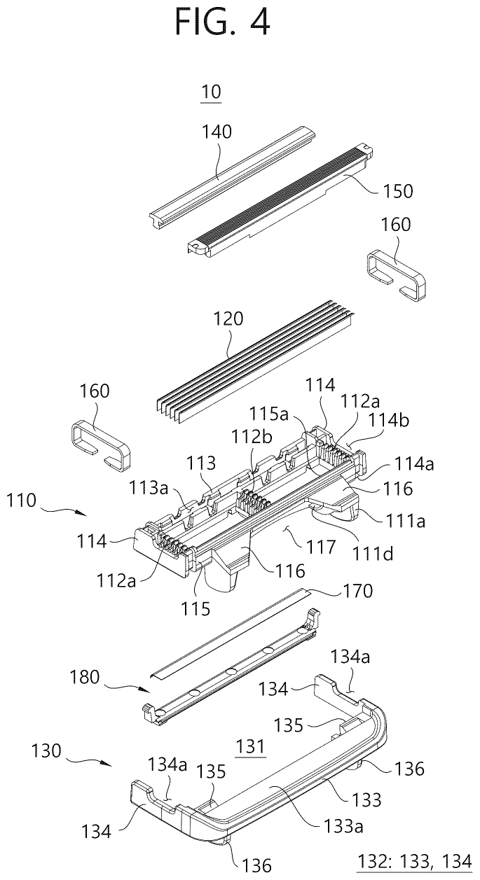

The connecting groove 111c may include a connecting member receiving groove 111d (see FIG. 4) extending to the inside of the pair of guide surfaces 111b at both ends. The connecting member receiving groove 111d is a space in which at least a portion of the connecting member is accommodated. The indicator 152 and the connecting member receiving groove 111d may be arranged on the same line in the longitudinal direction.

Referring to FIG. 3, the indicator 152 may be arranged between the blade housing 110 and the housing cover 130.

In addition, the indicator 152 may be provided between the razor blade 120 and the front end (for example, the front end portion of the first guard support (116, see FIG. 4)) of the blade housing 110. The indicator 152 may be provided closer to the frontmost razor blade 120 than the front end of the blade housing 110.

The indicator 152 may provide mounting information of the razor handle 40. The mounting information may include information related to an entry position of the razor handle 40 with respect to the connector 111, information related to the entry direction of the razor handle 40 with respect to the connector 111, information related to the mounting state of the razor handle 40 with respect to the connector (111), or the like.

That is, the user may recognize the position of the indicator 152 as the entry position into which the connecting member of the razor handle 40 should enter in order to couple with the connector 111. For this purpose, the indicator 152 may be formed with a color different from that of the connector 111 or the blade housing 110.

In addition, the user may recognize the direction indicated by the indicator 152 as the direction in which the connecting member of the razor handle 40 should enter in order to couple with the connector 111. For this purpose, the indicator 152 may be displayed so that the longitudinal width gradually decreases along the direction in which the connecting member of the razor handle 40 enters.

The mounting information provided by the indicator 152 may include the type of the connecting member that can be coupled with the connector 111. Even when the razor cartridge and the razor handle are products of the same manufacturer, there are cases in which they cannot be coupled with each other depending on the model. The indicator 152 may be displayed in different colors and/or shapes according to the coupling structure of the connector 111, so that the user can easily identify the razor handle 40 that can be coupled with the corresponding razor cartridge 10 through the indicator 152. For example, when a razor cartridge 10 manufactured by a specific manufacturer is divided into three types of connectors 111, each razor cartridge 10 may include an indicator 152 of one of the three colors and/or shapes according to the type of the connector 111. The manufacturer may also apply a new color and/or shape of the indicator 152 to the razor cartridge 10 to which a newly developed connector 111 is applied.

In addition, the razor handle may also be distinguished by color according to the type of the connecting member coupled to the connector 111. For example, the razor handle may include a handle of a different color depending on the type of the connecting member, or at least a portion of the connecting member may be manufactured in a different color. The user can easily recognize that a razor cartridge 10 can be coupled when the color of the razor handle and the color of the indicator 152 are the same. Accordingly, the user can easily distinguish the razor cartridge 10 that can be coupled to the razor handle that he or she holds by color, and conversely, the user can also easily distinguish the razor handle that can be coupled to the razor cartridge 10 that he or she holds.

In addition, when the connecting member of the razor handle 40 is normally coupled to the connector 111, the indicator 152 may be arranged to be completely covered by the connecting member. Accordingly, the user can determine the mounting status of the razor handle 40 with respect to the connector 111 based on whether at least a portion of the indicator 152 is visible in a state where the razor handle 40 is coupled to the razor cartridge 10. That is, when the indicator 152 is not visible, it is easy to recognize that the razor handle 40 is properly coupled to the razor cartridge 10, and when at least part of the indicator 152 is visible, it is easy to recognize that the razor handle 40 is not properly coupled to the razor cartridge 10.

As illustrated in FIG. 3, the connector 111 may be arranged so as not to overlap with the plurality of razor blades 120. This arrangement relationship allows shaving residue (for example, shaving cream, cut hair, or the like) to be effectively discharged together with the washing water into the space between the plurality of razor blades 120.

The razor blade 120 is formed with a sharp cutting edge (not illustrated) at an end portion thereof. Referring to FIG. 2, the razor blade 120 is mounted or supported on the blade housing 110 so that the cutting edge is exposed to the upper surface of the blade housing 110. In addition, the razor blade 120 is mounted or supported on the blade housing 110 so that the cutting edge faces the front of the blade housing 110.

The housing cover 130 is connected to the blade housing 110 and expands the guard region formed at the front of the razor blade 120. The guard region is located at the front of the razor blade 120 and may perform the function of supporting or pulling the skin by coming into contact with the skin before the razor blade 120 during the shaving process.

Hereinafter, with reference to an exploded perspective view, the components of the razor cartridge 10 according to one embodiment of the present disclosure will be described in more detail.

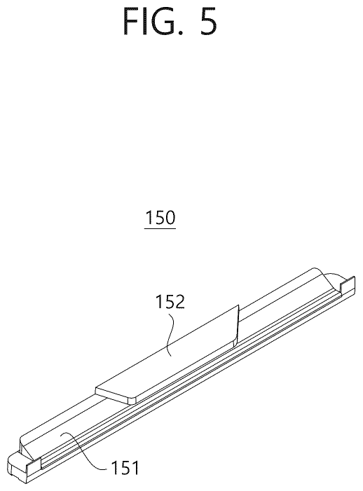

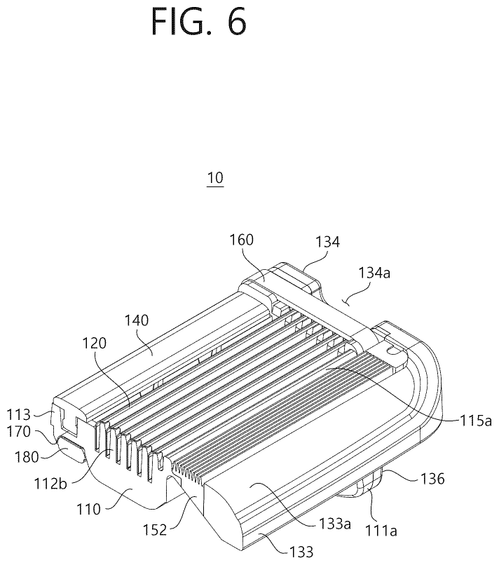

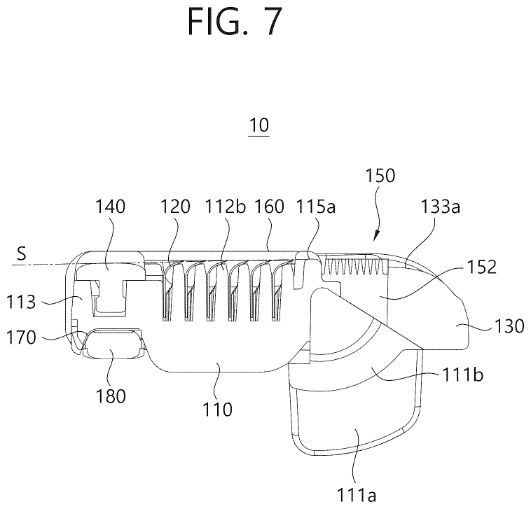

FIG. 4 is an exploded perspective view of the razor cartridge according to one embodiment of the present disclosure, FIG. 5 is a perspective view of a lower surface of an elastic guard of the razor cartridge according to one embodiment of the present disclosure, FIG. 6 is a perspective view illustrating a cross section of the razor cartridge according to one embodiment of the present disclosure, and FIG. 7 is a sectional view of the razor cartridge according to one embodiment of the present disclosure.

Referring to FIGS. 3 and 4, as described above, the razor cartridge 10 according to one embodiment of the present disclosure includes the blade housing 110, the plurality of razor blades 120 and the housing cover 130, and may further include at least some of a lubricating band 140, an elastic guard 150, a clip 160, a trimming blade 170, and a trimmer support 180.

Referring to FIG. 4, the blade housing 110 includes a rear portion 113 positioned at the rear of the razor blade 120, side portions 114 positioned at each of the two sides of the razor blade 120, and a front portion 115 positioned at the front of the razor blade 120.

First razor blade supports 112a for supporting and accommodating both sides of the razor blade 120 may be provided on the side portions 114 on both sides. A second razor blade support 112b may be provided between the first razor blade support 112a on both sides to support and accommodate the central portion of the razor blade 120. The second razor blade support 112b may be configured to connect the front portion 115 and the rear portion 113. The first razor blade support 112a and/or the second razor blade support 112b may be configured to elastically support the razor blade 120.

A space between the first razor blade support 112a and the second razor blade support 112b may be formed to penetrate in the up and down direction. The space between the first razor blade support 112a and the second razor blade support 112b may be used as a rinsing space in which shaving residue is discharged.

A clip groove 114a for accommodating the clip 160 may be formed in the side portion 114. The clip 160 is positioned on the upper side of both sides of the razor blade 120 to prevent the razor blade 120 from being separated upward. The clip groove 114a may be formed to be positioned on the same line in the transverse direction as the first razor blade support 112a.

Referring to FIGS. 4 and 6, a first discharge hole 114b which is recessed to be opened in the outward direction of the blade housing 110 may be formed in the side portion 114. The first discharge hole 114b allows shaving residue existing between the razor blades 120 to be discharged laterally during the shaving process and/or the washing process.

The rear portion 113 may be formed to connect the side portions 114 on both sides, and a lubricating band accommodating groove 113a for accommodating a lubricating band 140 may be formed on an upper portion of the rear portion 113. The lubricating band 140 may be installed so that an upper surface thereof is exposed to the upper surface of the blade housing 110. The lubricating band 140 includes a lubricating material and allows the lubricating material to be applied to the skin surface that the razor blade 120 passes through during the shaving process. The lubricating material may include ingredients for protecting the skin after shaving.

Referring to FIG. 6, a trimmer accommodating groove (not illustrated) for accommodating the trimming blade 170 and the trimmer support 180 may be formed on a lower surface of the rear portion 113.

Referring to FIGS. 6 and 7, the trimmer support 180 is coupled to the rear portion 113 so that the trimming blade 170 is positioned between the trimmer support 180 and the lower surface of the rear portion 113. A lubricating material may be applied to the lower surface of the trimmer support 180.

The trimming blade 170 is a razor blade having a cutting edge formed therein, and is accommodated in the trimmer accommodating groove so that the cutting edge is exposed to the lower portion of the blade housing 110.

The front portion 115 may be formed to connect the side portions 114 on both sides, and a guard bar 115a arranged in front of the razor blade 120 may be formed on an upper surface of the front portion 115.

The guard bar 115a is positioned between the frontmost razor blade and the elastic guard 150. The guard bar 115a can support the skin during the shaving process and prevent the skin from being cut by the frontmost razor blade.

Referring to FIG. 5, a plane connecting the upper surface of the guard bar 115a and the upper surface of the lubricating band 140 may be defined as a shaving plane S. Alternatively, the shaving plane S may be defined as a plane connecting the upper surface of the guard bar 115a and a part of the upper surface of the rear portion 113. The cutting edge of the razor blade 120 may be positioned adjacent to the shaving plane S, and at least some of the razor blades 120 may be positioned below the shaving plane S or above the shaving plane S. For example, among the razor blades 120, the razor blades positioned at the front may be positioned so that cutting edges have a negative exposure value positioned lower than the shaving plane S to prevent skin cuts, and among the razor blades 120, the razor blades positioned at the rear may be positioned so that cutting edges have a positive exposure value positioned higher than the shaving plane S to ensure a cleaner shave, and among the razor blades 120, the razor blades positioned at the center may be positioned so that cutting edges have an exposure value of 0 positioned on the shaving plane S.

Referring to FIG. 4, the blade housing 110 may further include a first guard support 116 extending forward from the front portion 115.

The first guard support 116 supports the elastic guard 150. The elastic guard 150 is in close contact with the user's skin during the shaving process and pulls the skin to improve the shaving effect by the razor blade 120. In order for the elastic guard 150 to pull the user's skin more effectively, a pattern formed in an embossed or engraved shape may be formed on an upper surface of the elastic guard 150, and the upper surface of the elastic guard 150 may be formed of a material such as rubber or silicone.

Referring to FIG. 4, a through slit (117) penetrating in the up and down direction may be formed in the first guard support 116. Referring to FIG. 5, the elastic guard 150 may include a guard body 151 that is mounted on the first guard support 116 and has an upper surface exposed through the upper surface of the blade housing 110, and the indicator 152 that protrudes downward from a lower side of the guard body 151 to be inserted into the through slit 117. Referring to FIGS. 6 and 7, the indicator 152 may be inserted into the through slit 117 and exposed through the lower surface of the blade housing 110. According to an embodiment, the indicator 152 may not be formed to protrude downward from the lower side of the guard body 151 and may mean a part of the guard body 151 that is visually confirmed through the through slit 117.

Referring to FIG. 3, the through slit 117 may be formed to be located within the connecting groove 111c. The indicator 152 exposed to the lower surface of the blade housing 110 through the through slit 117 provides mounting information of the razor handle 40 within the connecting groove 111c. In order for the coupling direction of the razor handle 40 to be visually recognized, the through slit 117 may be formed to have a longitudinal width that gradually decreases along the entry direction of the razor handle 40.

In order for the user to easily visually recognize the indicator 152 exposed through the through slit 117, the elastic guard 150 and the blade housing 110 may be formed in different colors. Since the elastic guard 150 is formed of a different material from the blade housing 110, such as rubber or silicone, it is not difficult to manufacture the elastic guard 150 in a different color from the blade housing 110. Therefore, it is desirable to include the indicator 152 in the elastic guard 150, such as the razor cartridge 10 according to the present embodiment.

In FIG. 4, the through slit 117 is illustrated as having an open shape toward the front of the blade housing 110, but the through slit 117 may also be formed to be surrounded by the first guard support 116 in the front region of the blade housing 110.

Referring to FIG. 3 and FIG. 4, a lower surface of the front portion 115 may be provided with the pair of connecting posts 111a, the pair of guide surfaces 111b, and the connecting groove 111c as described above.

The housing cover 130 includes a razor blade window 131 through which at least a portion of the cutting edge of the razor blade 120 is exposed, and a window frame 132 formed to surround at least a portion of the razor blade window 131.

Referring to FIG. 4, the window frame 132 may include a front frame 133 positioned in front of the razor blade 120 and a side frame 134 positioned on each of both sides of the razor blade 120.

The side frame 134 may extend rearward from both sides of the front frame 133 and may be coupled to the outer side of the side portion 114 of the blade housing 110. Referring to FIG. 4 and FIG. 6, a second discharge hole 134a communicating with the first discharge hole 114b may be formed in the side frame 134. In a state where the housing cover 130 is coupled to the blade housing 110, the second discharge hole 134a may be arranged longitudinally parallel to the first discharge hole 114b. The first discharge hole 114b and the second discharge hole 134a enable the lateral discharge of shaving residue and the lateral inflow of washing water, thereby improving discharge and washing effects of shaving residue existing between the razor blades 120.

The front frame 133 includes the plastic guard 133a positioned in front of the razor blade 120.

The razor cartridge 10 according to the present embodiment has a newly formed plastic guard region compared to the conventional razor cartridge. In order to prevent the skin from excessively slipping in the plastic guard region during the shaving process, the plastic guard 133a may have at least a portion of the upper surface formed as an uneven region of an irregular pattern. The uneven region may be formed to have a longitudinal surface roughness (Ra) of between 100 and 300 micrometers.

The plastic guard 133a including the uneven region passes over the skin before the razor blade 120 during the shaving process, removes dead skin cells and/or excessively applied shaving foam attached to the skin or beard, and pulls the skin to improve the shaving effect by the razor blade 120.

Referring to FIG. 7, the upper surface of the plastic guard 133a may be located lower than the shaving plane S, and may be located lower than the cutting edge of the razor blade 120, the guard bar 115a, and/or the upper surface of the elastic guard 150.

A ratio of the area of the plastic guard 133a to a cartridge front region located in front of the razor blade 120 may be 0.2 to 0.9. The cartridge front region may be a concept including the guard bar 115a, the elastic guard 150, and the front frame 133.

A ratio of the area of the uneven region to the cartridge front region may be 0.2 to 0.3.

In FIG. 4 or the like, the example is illustrated in which the through slit 117 is formed in the blade housing 110, but according to an embodiment, the through slit 117 may be formed in at least one of the blade housing 110 and the window frame 132. That is, at least a part of the through slit 117 may be formed to penetrate the plastic guard 133a in the up and down direction. In this case, the indicator 152 exposed through the through slit 117 may be surrounded by the blade housing 110 and the plastic guard 133a.

Referring to FIG. 4, the front frame 133 may further include a second guard support 135 extending rearward from the plastic guard 133a. The second guard support 135 may support the elastic guard 150 together with the first guard support 116. As illustrated in FIG. 4, the second guard support 135 may be configured as a pair of spaced apart from each other, and a space existing between the pair of second guard supports 135 may be connected to the through slit 117 to accommodate a part of the indicator 152.

Since the indicator 152 is supported in a state in which the front, back, left, and right sides are surrounded by the blade housing 110 and the housing cover 130 within the through slit 117, a contact area between the indicator 152 and the surrounding support structure (the blade housing 110 and the housing cover 130) increases, so that the indicator 152 is supported more firmly within the razor cartridge 10, and the indicator 152 is prevented from being separated from the razor cartridge 10 due to external impact, or the like.

Referring to FIG. 4 and FIG. 6, the front frame 133 may further include a pair of reinforcing posts 136 extending downwardly. The reinforcing posts 136 may each be coupled to the outer side of the connecting post 111a.

The reinforcing posts 136 and the side frame 134 may increase the contact area between the blade housing 110 and the housing cover 130, thereby strengthening the coupling force between the blade housing 110 and the housing cover 130.

The plastic guard 133a of the housing cover 130 may be formed of a light-transmitting material. That is, the plastic guard 133a may be formed of a transparent or translucent material. In this case, the user can visually check the shaved area through the plastic guard 133a during shaving.

Since the upper surface of the razor cartridge 10 remains in contact with the skin during shaving, the user shaves while checking the lower surface of the razor cartridge 10 through the mirror. Since the razor cartridge 10 according to the present embodiment has the plastic guard 133a formed of a light-transmitting material, the user can visually check the skin supported by the plastic guard 133a during shaving, and accurately recognize the current position of the razor blade 120 and the position of the skin to be shaved by the razor blade 120 later. In particular, when shaving a narrow region such as under the nose or a region requiring precise shaving, the shaving area and/or the area to be shaved can be visually checked through the plastic guard 133a, thereby enabling a safer and more precise shaving.

The housing cover 130 may be formed of a light-transmitting material only for the plastic guard 133a, or may be formed of a light-transmitting material only for the front frame 133. Alternatively, the housing cover 130 may be formed entirely of a light-transmitting material.

Referring to FIG. 3, the connector 111 of the blade housing 110 is formed of an opaque material, and when the plastic guard 133a, the front frame 133, or the housing cover 130 is formed of a light-transmitting material, the connector 111 may be more clearly visually distinguished from the lower surface of the razor cartridge 10.

The blade housing 110 may be formed of an opaque material to be distinguished from the housing cover 130, but depending on the embodiment, the blade housing 110 may also be formed of a light transmitting material.

The blade housing 110 and the housing cover 130 may be formed integrally. The blade housing 110 and the housing cover 130 may be formed integrally with an opaque material or may be formed integrally with a light-transmitting material. Alternatively, the blade housing 110 may be formed with an opaque material, and at least a portion (for example, the front frame 133 or the plastic guard 133a) of the housing cover 130 may be formed with a light-transmitting material, but the blade housing 110 and the housing cover 130 may be formed integrally by a method such as double injection.

Hereinafter, a razor cartridge according to another embodiment of the present disclosure will be described. For convenience of explanation, parts similar to one embodiment are given the same drawing reference numerals, and parts common to one embodiment are omitted for description.

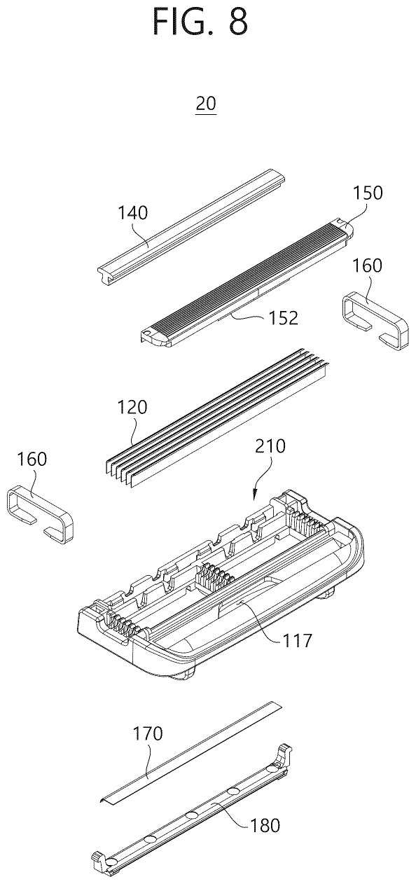

FIG. 8 is an exploded perspective view of a razor cartridge according to another embodiment of the present disclosure.

Referring to FIG. 8, a razor cartridge 20 according to another embodiment of the present disclosure includes the part described as the housing cover 130 in the razor cartridge 10 according to the one embodiment described above in the blade housing 210.

The blade housing 210 may be single-injected with an opaque material or a light-transmitting material. A part formed of a different material from the blade housing 210, such as an elastic guard 150, may be manufactured integrally with the blade housing 210 by a method such as double-injection.

The razor cartridge 20 according to another embodiment of the present disclosure may include a through slit 117 formed to penetrate the blade housing 210 upward and downward, and the through slit 117 may be formed to be surrounded by the blade housing 210 in the front region of the blade housing 210. Similar to the above-described embodiment, the through slit 117 may be formed to be located within the connecting groove 111c.

The indicator 152 may be provided at a lower side of the elastic guard 150, and may be inserted into the through slit 117 and exposed to the lower surface of the blade housing 210 through the connecting groove 111c.

The indicator 152 may be arranged to be surrounded by the blade housing 210. In this case, the peripheral portion of the indicator 152 is supported laterally by the blade housing 210 so that it is prevented from being separated from the blade housing 210 due to external impact, or the like.

The indicator 152 may be provided between the razor blade 120 and the front end of the blade housing 110. The indicator 152 may be provided to be closer to the frontmost razor blade 120 than the front end of the blade housing 110.

A person having ordinary skill in the art to which the present disclosure belongs will be able to understand that the present disclosure may be implemented in other specific forms without changing the technical idea or essential features thereof. Therefore, the embodiments described above should be understood as illustrative and not limiting in all respects. The scope of the present disclosure is indicated by the claims described below rather than the detailed description above, and all changes or modifications derived from the meaning and scope of the claims and their equivalent concepts should be interpreted as being included in the scope of the present disclosure.

What is claimed is:

1. A razor assembly comprising:
a razor handle;
at least one razor blade having a cutting edge formed thereon;
a blade housing including:
a razor blade mounting portion configured to accommodate the razor blade in a longitudinal direction,
an upper surface configured to expose the razor blade, and
a lower surface opposite to the upper surface; and
a connector disposed adjacent to the lower surface and including a connecting groove configured to at least partially receive the razor handle,
wherein an indicator providing mounting information of the razor handle is provided within the connecting groove.

2. The razor assembly of claim 1, wherein the mounting information includes information related to an entry direction of the razor handle relative to the connector.

3. The razor assembly of claim 1, wherein the mounting information includes information related to an entry position of the razor handle relative to the connector.

4. The razor assembly of claim 1, further comprising an elastic guard disposed in the blade housing,
wherein the blade housing is formed such that at least a portion of the elastic guard is exposed within the connecting groove on the lower surface, and
wherein the indicator comprises the elastic guard exposed within the connecting groove.

5. The razor assembly of claim 4, wherein the blade housing further includes a guard support supporting the elastic guard, and
wherein the guard support includes a through slit configured to expose at least a portion of the elastic guard within the connecting groove.

6. The razor assembly of claim 5, wherein the through slit is surrounded by the blade housing in a front region of the blade housing.

7. The razor assembly of claim 5, wherein a longitudinal width of the through slit gradually decreases along the entry direction of the razor handle.

8. The razor assembly of claim 4, wherein the elastic guard is formed in a color different from that of the blade housing.

9. The razor assembly of claim 4, further comprising a housing cover including a razor blade window configured to expose at least a portion of the cutting edge and the elastic guard and a window frame surrounding at least a portion of the razor blade window and connected to the blade housing,
wherein at least one of the window frame or the blade housing comprises a through slit configured to expose at least a portion of the elastic guard within the connecting groove.

10. The razor assembly of claim 9, wherein the indicator is surrounded by the blade housing and the window frame.

11. The razor assembly of claim 1, wherein the indicator is provided between the razor blade and a front end portion of the blade housing and provided closer to the razor blade than the end portion of the blade housing.

12. A razor cartridge comprising:
at least one razor blade having a cutting edge formed thereon; and
a blade housing including:
a razor blade mounting portion formed at an upper surface configured to accommodate the razor blade in a longitudinal direction, and
a connector provided at a lower surface to which a razor handle is coupled,
wherein the connector includes a pair of connecting posts formed at both sides of a space configured to at least partially receive the razor handle, and
wherein an indicator indicating an entry position of the razor handle is configured to be displayed between the pair of connecting posts.

13. The razor cartridge of claim 12, wherein the pair of connecting posts and the indicator are arranged on the same line in the longitudinal direction.

14. The razor cartridge of claim 12, further comprising an elastic guard arranged on an upper surface of the blade housing,
wherein the blade housing is formed such that at least a portion of the elastic guard is exposed between the pair of connecting posts through a lower surface of the blade housing, and
wherein the indicator comprises the elastic guard exposed between the pair of connecting posts.

15. The razor cartridge of claim 14, further comprising a guard support supporting the elastic guard,
wherein the guard support includes at least a portion of a through slit configured to enable at least a portion of the elastic guard to be exposed through a lower surface of the blade housing between the pair of connecting posts.

16. The razor cartridge of claim 15, wherein a longitudinal width of the through slit gradually decreases along an entry direction of the razor handle.

17. The razor cartridge of claim 15, wherein the elastic guard is formed in a color different from that of the blade housing.

18. The razor cartridge of claim 15, further comprising a housing cover including a razor blade window configured to expose at least a portion of the cutting edge and the elastic guard and a window frame formed to surround at least a portion of the razor window and connected to the blade housing,
wherein the indicator is surrounded by the blade housing and the window frame.
